(19) United States
(12) Patent Application Publication
(10) Pub. No.: US 2013/0265509 A1
(43) Pub. Date: Oct. 10, 2013

(54) LIQUID CRYSTAL LENS PANEL AND STEROSCOPIC IMAGE DISPLAY PANEL HAVING THE SAME

(71) Applicants: Suk Choi, Seongnam-si (KR); Sung-Hwan Hong, Suwon-si (KR); Su-Jin Kim, Seoul (KR); Hyeok-Jin Lee, Seongnam-si (KR)

(72) Inventors: Suk Choi, Seongnam-si (KR); Sung-Hwan Hong, Suwon-si (KR); Su-Jin Kim, Seoul (KR); Hyeok-Jin Lee, Seongnam-si (KR)

(21) Appl. No.: 13/599,661

(22) Filed: Aug. 30, 2012

(30) Foreign Application Priority Data
Apr. 4, 2012 (KR) 10-2012-0034997

(51) Int. Cl. G02F 1/1335; G02F 1/1337; G02F 1/1343

(52) U.S. Cl. 349/15; 349/139; 349/128; 349/96; 349/158

(57) ABSTRACT

A liquid crystal lens panel includes a first substrate, a second substrate and a liquid crystal layer. The first substrate includes a common electrode. The second substrate includes a plurality of first electrodes and a plurality of second electrodes facing the common electrode. The liquid crystal layer is disposed between the first and second substrates and includes first and second liquid crystal molecules. The first liquid crystal molecules are aligned at a first pretilt angle with respect to the first substrate. The first liquid crystal molecules are adjacent to the first substrate. The second liquid crystal molecules are aligned at a second pretilt angle with respect to the second substrate. The second liquid crystal molecules are adjacent to the second substrate.

### CROSS-REFERENCE TO RELATED APPLICATION

This application claims priority under 35 U.S.C. §119 to Korean Patent Application No. 10-2012-0034997, filed on Apr. 4, 2012 in the Korean Intellectual Property Office, the contents of which are herein incorporated by reference in their entireties.

### TECHNICAL FIELD

Exemplary embodiments of the present invention relate to a liquid crystal lens panel and a stereoscopic image display panel having the liquid crystal lens panel. More particularly, exemplary embodiments of the present invention relate to a liquid crystal lens panel used to drive a high speed display apparatus and a three dimensional image display panel having the liquid crystal lens panel.

### DISCUSSION OF THE RELATED ART

Three-dimensional (“3D”) stereoscopic image display apparatuses can display 3D images using binocular parallax between a human's eyes. The binocular parallax-based 3D display apparatuses may be classified into stereoscopic types and auto stereoscopic types. The auto stereoscopic types of 3D display apparatuses include barrier types, lenticular types, and liquid crystal lens types.

A stereoscopic image display apparatus of a liquid crystal lens panel type includes a display panel and a liquid crystal lens panel disposed on the display panel.

The display panel includes an array substrate, an opposite substrate, and a liquid crystal layer between the array substrate and the opposite substrate. The liquid crystal lens panel includes a top plate, a bottom plate, and a liquid crystal layer between the top plate and bottom plate.

The liquid crystal lens panel displays a three dimensional image having multiple viewpoints obtained by refracting three dimensional mode plane images from the display panel. However, the number of the viewpoints is limited by the resolution of the display panel.

In order to increase the number of the viewpoints, e.g., by two times, the liquid crystal lens panel is driven so that the locations of focuses of the liquid crystal lens panel generated during odd-numbered frames are different from those generated during even-numbered frames. Such an increase in the number of viewpoints may be achieved by driving the liquid crystal lens panel at a higher speed, which may result in an increase in the response speed of liquid crystal molecules.

### SUMMARY

Exemplary embodiments of the present invention provide a liquid crystal lens panel that can increase response time of liquid crystal molecules and a stereoscopic display panel having the liquid crystal lens panel.

According to an exemplary embodiment of the present invention, a liquid crystal lens panel includes a first substrate, a second substrate and a liquid crystal layer. The first substrate includes a common electrode. The second substrate includes a plurality of first electrodes and a plurality of second electrodes facing the common electrode. The liquid crystal layer is disposed between the first and second substrates. The liquid crystal layer includes first and second liquid crystal molecules. The first liquid crystal molecules are aligned at a first pretilt angle with respect to the first substrate. The first liquid crystal molecules are adjacent to the first substrate, and the second liquid crystal molecules are aligned at a second pretilt angle with respect to the second substrate.

In an embodiment of the present invention, the first pretilt angle may be from about 85 degrees to about 89 degrees, and the second pretilt angle may be from about 0 degrees to about 2 degrees.

In an embodiment of the present invention, the liquid crystal layer may further include a third liquid crystal molecules disposed between the first liquid crystal molecules and the second liquid crystal molecules, and the third liquid crystal molecules have a third pretilt angle between the first pretilt angle and the second pretilt angle.

In an embodiment of the present invention, the first substrate may be disposed on the common electrode, and the first substrate may further include a first alignment layer that aligns the first liquid crystal molecules at the first pretilt angle. The second substrate may include a second alignment layer on the first and second electrodes. The second alignment layer aligns the second liquid crystal molecules at the second pretilt angle.

In an embodiment of the present invention, the first and the second electrodes may be extended to a first direction. The first alignment layer is rubbed in the first direction. The second alignment layer is rubbed in a second direction opposing to the first direction.

In an embodiment of the present invention, the first substrate may further include a first base substrate and a first polarizing plate. The first base substrate includes a first surface and a second surface opposite to each other. The common electrode is formed on the first surface of the first base substrate. The first polarizing plate may be disposed on the second surface of the first base substrate. The second substrate may further include a second base substrate and a second polarizing plate. The second base substrate includes first and second surfaces opposite to each other. The first and second electrodes are formed on the first surface of the second substrate. The second polarizing plate may be disposed on the second surface of the second base substrate. At least one of the first or the second polarizing plate may include a transmitting axis parallel or substantially parallel with the first or second direction. In an embodiment of the present invention, the first alignment layer may include a first reactive polymer. The first liquid crystal molecules are aligned at the first pretilt angle. The second alignment layer may include a second reactive polymer. The second liquid crystal molecules are aligned at the second pretilt angle.

In an embodiment of the present invention, voltages are respectively applied to the first and second electrodes. The liquid crystal layer may operate as a Fresnel lens.

According to an exemplary embodiment of the present invention, a liquid crystal lens panel includes a first base substrate, a common electrode, a second base substrate, a plurality of first electrodes and a plurality of second electrodes, a liquid crystal layer, a first alignment layer, and a second alignment layer. The common electrode may be disposed on the first base substrate. The second base substrate is positioned opposite to the first base substrate. The plurality of first electrodes and the plurality of second electrodes are disposed on the second base substrate. The plurality of first electrodes and the plurality of second electrodes are positioned opposite to the common electrode. The liquid crystal layer may be disposed between the first and the second electrodes and the common electrode. The first alignment layer may be disposed on the common electrodes. The first alignment layer may align first liquid crystal molecules of the liquid crystal layer at a first pretilt angle with respect to first substrate. The first liquid crystal molecules are adjacent to the common electrode. The second alignment layer may be disposed on the first and second electrodes. The second alignment layer may align second liquid crystal molecules of the liquid crystal layer at a second pretilt angle with respect to the second substrate. The second liquid crystal molecules are adjacent to the first and second electrodes.

In an embodiment of the present invention, the first pretilt angle may be from about 85 degrees to about 89 degrees, and the second pretilt angle may be from about 0 degrees to about 2 degrees.

In an embodiment of the present invention, the liquid crystal layer may further include third liquid crystal molecules disposed between the first liquid crystal molecules and the second liquid crystal molecules, and the third liquid crystal molecules have a third pretilt angle between the first pretilt angle and the second pretilt angle.

In an embodiment of the present invention, the first and the second electrodes may extend in a first direction. The first alignment layer is rubbed in the first direction, and the second alignment layer is rubbed in a second direction opposite to the first direction.

In an embodiment of the present invention, the first base substrate includes a first surface and a second surface opposite to each other, and the second base substrate includes a first surface and a second surface opposite to each other. The common electrode is formed on the first surface of the first base substrate, and the first and second electrodes are formed on the first surface of the second base substrate. The liquid crystal lens panel may further include a first polarizing plate on the second surface of the first base substrate. A second polarizing plate is disposed on the second surface of the second base substrate. The first or second polarizing plate may include a transmitting axis parallel or substantially parallel with the first or second direction.

In an embodiment of the present invention, voltages are respectively applied to the first and second electrodes. The liquid crystal layer may operate as a Fresnel lens.

According to an exemplary embodiment of the present invention, a stereoscopic image display panel may include a display panel and a liquid crystal lens panel. The display panel displays an image. The liquid crystal lens panel is disposed on the display panel and displays a three dimensional stereoscopic image. The liquid crystal lens panel may include a first substrate, a second substrate and a liquid crystal layer. The first substrate may include a common electrode. The second substrate may include a plurality of first electrodes and a plurality of second electrodes facing the common electrode. The liquid crystal layer is disposed between the first and second substrates and includes first and the second liquid crystal molecules. The first liquid crystal molecules are aligned at a first pretilt angle with respect to the first substrate. The first liquid crystal molecules are adjacent to the first substrate. The second liquid crystal molecules are aligned at a second pretilt angle with respect to the second substrate. The second liquid crystal molecules are adjacent to the second substrate.

In an embodiment of the present invention, the first pretilt angle may be from about 85 degrees to about 89 degrees, and the second pretilt angle may be from about 0 degrees to about 2 degrees.

In an embodiment of the present invention, the second substrate may be disposed between the first substrate and the display panel. The first substrate may further include a first base substrate, a first alignment layer and a first polarizing plate. The first base substrate includes a first surface and a second surface opposite to each other. The common electrode is formed on the first surface of the first base substrate. The first alignment layer is disposed on the common electrode. The first liquid crystal molecules of the first alignment layer are aligned at the first pretilt angle. The first polarizing plate may be disposed on the second surface of the first base substrate. The second substrate may further include a second base substrate, a second alignment layer and a second polarizing plate. The second base substrate includes a first surface and a second surface opposite to each other, wherein the first and second electrodes are formed on the first surface of the second substrate. The second alignment layer is disposed on the first and the second electrodes. The second liquid crystal molecules are aligned at the second pretilt angle. The second polarizing plate is disposed on the second surface of the second base substrate.

In an embodiment of the present invention, the first alignment layer is rubbed in the first direction. The second alignment layer is rubbed in the second direction opposite to the first direction. The first polarizing plate may include a transmitting axis parallel or substantially parallel with the first or the second direction.

In an embodiment of the present invention, the first substrate may be disposed between the display panel and the second substrate. The first substrate may further include a first base substrate and a first alignment layer. The first alignment layer is disposed on a common electrode. The first liquid crystal molecules of the first alignment layer are aligned at the first pretilt angle. The second substrate may further include a second base substrate, a second alignment layer and a second polarizing plate. The second base substrate includes a first surface and a second surface opposite to each other. The first and second electrodes are formed on the first surface of the second base substrate. The second base substrate is positioned opposite to the first base substrate. The second alignment layer is disposed on the first and the second electrodes. The second liquid crystal molecules of the second alignment layer are aligned at the second pretilt angle. The second polarizing plate is disposed on the second surface of the second base substrate.

In an embodiment of the present invention, the first alignment layer is rubbed in the first direction. The second alignment layer is rubbed in the second direction opposite to the first direction. The polarizing plates may include a transmitting axis parallel or substantially parallel with one of the first and the second directions.

According to an embodiment, there is provided a liquid crystal panel including a first substrate, a second substrate facing the first substrate, and a liquid crystal layer between the first and second substrates, wherein some of liquid crystal molecules in the liquid crystal layer, which are adjacent to the first substrate, are pre-tilted at a first angle with respect to the first substrate, and some of the liquid crystal molecules in the liquid crystal layer, which are adjacent to the second substrate, are pre-tilted at a second angle with respect to the second substrate.

The first angle is in a range from about 85 degrees to about 89 degrees, and the second angle is in a range from about 0 degrees to about 2 degrees.

According to the liquid crystal lens panel and the stereoscopic image display panel including the liquid crystal lens panel, the first liquid crystal molecules adjacent to the first substrate are aligned at a first pretilt angle with respect to the first substrate, and the second liquid crystal molecules adjacent to the second substrate are aligned at a second pretilt angle with respect to the second substrate. Thus, the response time of liquid crystal molecules may be decreased.

Effective retardation may be increased by initially aligning the second liquid crystal molecules by no more than about 2 degrees. Thus, a refractive index of the liquid crystal lens panel may be easily formed.

### BRIEF DESCRIPTION OF THE DRAWINGS

The embodiments of the present invention will become more apparent by the detailed description with reference to the accompanying drawings, in which;

FIG. 1 is a cross-sectional view illustrating a stereoscopic image display apparatus having a stereoscopic image display panel according to an exemplary embodiment of the present invention;

FIG. 2A is a cross-sectional view illustrating the liquid crystal lens panel of FIG. 1, which includes initially aligned liquid crystal molecules;

FIG. 2B is a conceptual view illustrating a refractive index distribution of a unit lens;

FIG. 3 is an exploded plan view for describing a polarizing direction of the liquid crystal lens panel in FIG. 2;

FIGS. 4A and 4B are views illustrating states of the liquid crystal molecules illustrated in FIG. 2A when application of a voltage turns on/off;

FIG. 5A is a graph illustrating a relationship between on-time and transmittance of liquid crystal molecules according to an embodiment of the present invention;

FIG. 5B is a graph illustrating a relationship between off-time and transmittance of liquid crystal molecules according to an embodiment of the present invention;

FIGS. 6A and 6B are views illustrating the number of viewpoints of even-numbered and odd-numbered frames according to embodiments of the present invention;

FIG. 7 is a cross-sectional view illustrating a liquid crystal lens panel of a stereoscopic image display panel according to an exemplary embodiment of the present invention; and

FIG. 8 is a plan view illustrating a polarizing direction of the liquid crystal lens panel in FIG. 7.

### DETAILED DESCRIPTION OF EXEMPLARY EMBODIMENTS

Hereinafter, embodiments of the present invention will be described in detail with reference to the accompanying drawings. As those skilled in the art would realize, the described embodiments may be modified in various different ways, all without departing from the spirit or scope of the present invention.

In the drawings, the thickness of layers, films, panels, regions, etc., may be exaggerated for clarity. Like reference numerals may designate like or similar elements throughout the specification and the drawings. It will be understood that when an element such as a layer, film, region, or substrate is referred to as being “on”, “connected to”, or “coupled to” another element, it can be directly on, connected or coupled to the other element or intervening elements may also be present.

As used herein, the singular forms, “a”, “an”, and “the” are intended to include the plural forms as well, unless the context clearly indicates otherwise.

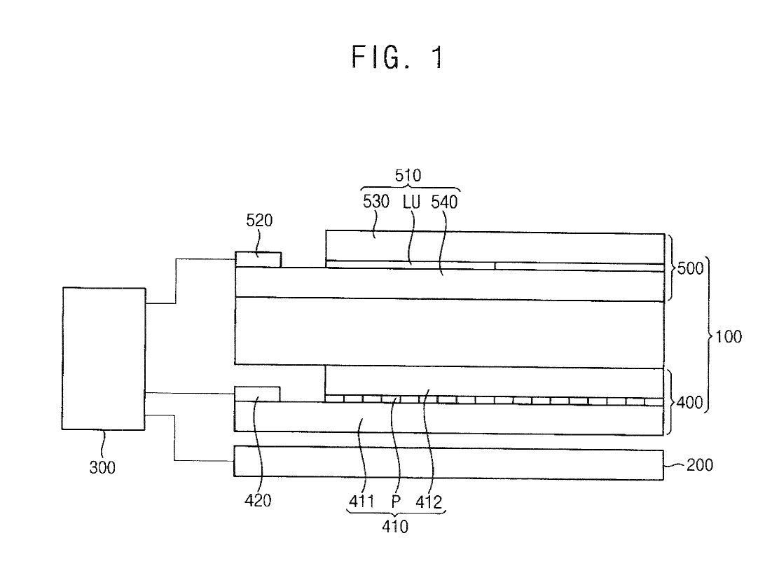

FIG. 1 is a cross-sectional view illustrating stereoscopic image display apparatus having a stereoscopic image display panel according to an exemplary embodiment of the present invention.

Referring to FIG. 1, a stereoscopic image display apparatus includes a stereoscopic image display panel 100, a light source part 200 and a controller part 300. The stereoscopic image display panel 100 includes a display part 400 and a lens part 500 disposed on the display part 400.

The display part 400 includes a display panel 410 and a display driver part 420 driving the display panel 410.

The display panel 410 displays two-dimensional and three-dimensional images. The display panel 410 includes an array substrate 411, an opposite substrate 412 facing the array substrate 411 and pixel parts P disposed between the array substrate 411 and the opposite substrate 412.

The array substrate 411 includes gate lines extended in a first direction, data lines extended in a second direction different from the first direction, pixel electrodes, and switching devices. The switching devices include source electrodes connected to corresponding ones of the data lines, gate electrodes connected to corresponding ones of the gate lines, and drain electrodes separated from the source electrodes. The pixel electrodes are connected to corresponding ones of the switching devices.

The opposite substrate includes a common electrode facing the pixel electrodes.

The lens part 500 includes a liquid crystal lens panel 510 and a lens driver part 520 that drives the liquid crystal lens panel 510. The liquid crystal lens panel 510 is disposed on the display panel 410. According to an embodiment, optical adhesives or a gap controlling substrate is disposed between the liquid crystal lens panel 510 and the display panel 410.

In a plane mode, the liquid crystal lens panel 510 displays a two-dimensional image provided from the display panel 410 without changing the two-dimensional image. In a stereoscopic mode, the liquid crystal lens panel 510 displays a three-dimensional mode plane image provided from the display panel 410 as a three-dimensional stereoscopic image.

The liquid crystal lens panel 510 includes a first substrate 530 and a second substrate 540 between the first substrate 530 and the display panel 410. The second substrate 540 is positioned opposite to the first substrate 530. A liquid crystal layer is disposed between the first substrate 530 and the second substrate 540. The first substrate 530, the second substrate 540 and the liquid crystal layer form a unit lens LU extended in a third direction different from the first and second directions.

The light source part 200 is disposed on a lower part of the stereoscopic image display panel 100. The light source part 200 provides light to the stereoscopic image display panel 100. For example, according to an embodiment, the light source part 200 includes a light source and a light guide plate.

The controller part 300 is connected to the display part 400, the lens part 500 and the light source part 200 and controls the display part 400, the lens part 500 and the light source part 200.

The controller part 300 drives the stereoscopic image display panel 100 in the plane mode or the stereoscopic mode according to a mode signal provided from an outside source.

For example, according to an embodiment, the controller part 300 controls the lens driver part 520 so that the lens driver part 520 applies an off-voltage to the liquid crystal lens panel 510 according to a plane mode signal. The controller part 300 controls the display driver part 420 so that the display panel 410 displays a two-dimensional mode plane image according to the plane mode signal. Thus, the liquid crystal lens panel 510 transmits light from the display panel 400 without refraction. Thus, the liquid crystal lens panel 510 may display a two-dimensional mode plane image from the display panel without changing the two-dimensional mode plane image.

The controller part 300 controls the lens driver part 520 so that the lens driver part 520 applies an on-voltage to the liquid crystal lens panel 510 according to a stereoscopic mode signal. The controller part 300 controls the display driver part 420 so that the display panel 410 displays a three-dimensional mode plane image according to the stereoscopic mode signal. Thus, the liquid crystal lens panel 510 operates as a Fresnel lens and refracts light provided from the display panel 410. Thus, the liquid crystal lens panel 510 may display the three-dimensional mode plane image provided from the display panel 410 as a three-dimensional stereoscopic image.

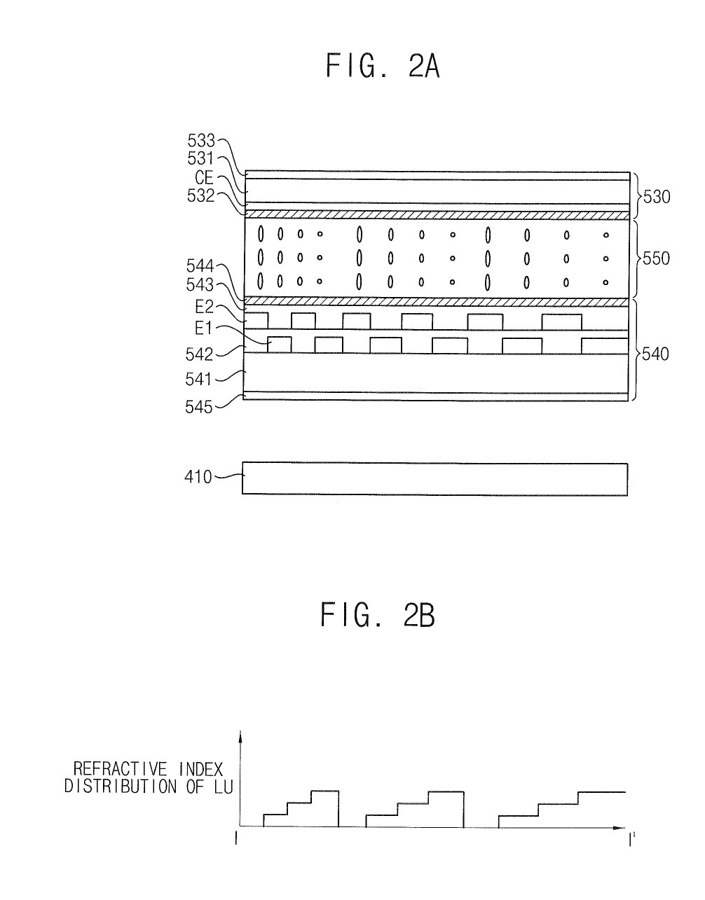

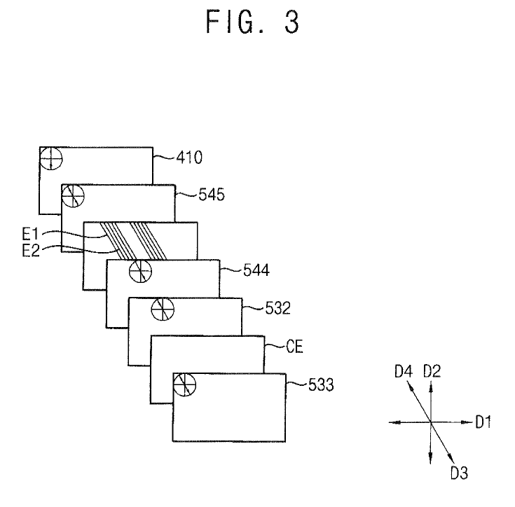

FIG. 2A is a cross-sectional view illustrating the liquid crystal lens panel of FIG. 1, which includes initially aligned liquid crystal molecules. FIG. 2B is a conceptual view illustrating a refractive index distribution of a unit lens. FIG. 3 is an exploded plan view for describing a polarizing direction of the liquid crystal lens panel in FIGS. 2A and 2B.

Referring to FIGS. 2A and 2B and FIG. 3, the first substrate 530 includes a first substrate 531, a common electrode CE, a first alignment layer 532 and a first polarizing plate 533.

The common electrode CE is disposed on a first substrate of the first base substrate 531.

The first polarizing plate 533 is disposed on a second surface of the first base substrate 531. The second surface of the first base substrate 531 is positioned opposite to the first surface of the first base substrate 531. The first polarizing plate 533 includes a transmitting axis parallel or substantially parallel with a third direction D3, in which the lens unit LU extends, and a fourth direction D4 which is an opposite direction of the third direction D3.

The first alignment layer 532 is disposed on the common electrode. The first alignment layer 532 enables first liquid crystal molecules that are included in the liquid crystal layer 550 and adjacent to the first substrate 530 to be aligned perpendicular or substantially perpendicular to the first substrate 530. The first alignment layer 532 is rubbed in the fourth direction D4. The rubbed first alignment layer 532 allows the first liquid crystal molecules of the liquid crystal layer 550 to be aligned perpendicular or substantially perpendicular to the first substrate 530 and to have directivity in the fourth direction D4. Thus, the first alignment layer prevents the first liquid crystal molecules and other liquid crystal molecules adjacent to the first liquid crystal molecules from moving in a direction perpendicular or substantially perpendicular to the transmitting axis of the first polarizing 533 so that creation of shadow lines and a lowering of optical efficiency may be prevented.

The first liquid crystal molecules have a first pretilt angle θ1 with respect to the first base substrate 531. For example, according to an embodiment, the first pretilt angle θ1 is from about 85 degrees to about 89 degrees. Thus, when an off-voltage is applied to the liquid crystal lens panel 510, the first liquid crystal molecules may turn back to the initially aligned state more quickly.

Alternatively, the first alignment layer 532 includes a reactive polymer and may thus allow the first liquid crystal molecules of the liquid crystal layer 550, which are adjacent to the first substrate 530, to be aligned perpendicular or substantially perpendicular to the first substrate 530 and to have directivity. For example, according to an embodiment, an exposure electric field state method is used to create the first alignment layer 532. The exposure electric field state method applies a predetermined voltage to the reactive polymer and irradiates ultraviolet UV rays more than about 3J to the reactive polymer.

The second substrate 540 includes a second base substrate 541, first electrodes E1, a first insulating layer 542, second electrodes E2, a second insulating layer 543, a second alignment layer 544 and a second polarizing plate 545. The second substrate 540 is positioned opposite to the first substrate 530.

The first electrodes E1 are disposed on a first surface of the second base substrate 541. The first electrodes E1 are extended on the first surface of the second base substrate 541 in the third direction D3. The first electrodes E1 are positioned opposite to the common electrode CE. A potential difference between the first electrodes E1 and the common electrode CE enables liquid crystal molecules disposed between the first electrodes E1 and the common electrode CE to be aligned.

The first insulating layer 542 is disposed on the second base substrate 541 on which the first electrodes E1 are disposed.

The second electrodes E2 are disposed on the first insulating layer 542. The second electrodes E2 are extended in the third direction D3 on the first insulating layer 542. The second electrodes E2 are positioned opposite to the common electrode CE. A potential difference between the second electrodes E2 and the common electrode CE enables liquid crystal molecules disposed between the second electrodes E2 and the common electrode CE to be aligned.

Each of the first electrodes E1 is disposed between two adjacent ones of the second electrodes E2. Each of the second electrodes E2 is disposed between two adjacent ones of the first electrodes E1. For example, the first electrodes E1 and the second electrodes E2 are alternately disposed.

One of the first electrodes E1 and the common electrode CE or one of the second electrodes E2 and the common electrode CE may form a sub-zone having a predetermined refractive index. Consecutive sub-zones form a zone having inconsecutive refractive indexes. The zones form the unit lens LU, and the unit lens LU may operate as or similarly to a Fresnel lens. According to an embodiment, the first electrode E1 and the second electrode E2 that are included in each zone have the same or substantially the same width. According to an embodiment, the first electrode E1 and second electrode E2 of a first zone of the zones have widths different from widths of the first and second electrodes E1 and E2 of a second zone of the zones, which is adjacent to the first zone.

The second insulating layer 543 is disposed on the first insulating layer 542 on which the second electrodes E2 are disposed.

According to an embodiment, the first insulating layer 542 and the second insulating layer 543 include the same or substantially the same substance.

The second polarizing plate 545 is disposed on a second surface facing the first surface of a second substrate 541. The second polarizing plate 545 has a transmitting axis in the third direction D3, in which the lens unit LU extends, and in a fourth direction D4 that is an opposite direction of the third direction D3. Thus, a loss of light provided from the display panel 410 may be decreased.

The second alignment layer 544 is disposed on the second insulating layer 543. The second alignment layer 544 enables second liquid crystal molecules of the liquid crystal layer which are adjacent to the second substrate 540 to be aligned in parallel or substantially in parallel with the second substrate 540. The second alignment layer 544 is rubbed in the third direction D3. The rubbed second alignment layer 544 allows the second liquid crystal molecules of the liquid crystal layer 550 to be aligned in parallel or substantially in parallel with the second substrate 540 and to have directivity in the third direction D3. Thus, the second alignment layer prevents the second liquid crystal molecules and other liquid crystal molecules adjacent to the second liquid crystal molecules from moving in the direction perpendicular or substantially perpendicular to the transmitting axis of the second polarizing plate 545. Thus, creation of shadow lines and a lowering of optical efficiency may be prevented.

According to an embodiment, the second liquid crystal molecules have a second pretilt angle θ2 with respect to the second base surface 541. For example, according to an embodiment, the second pretilt angle θ2 is from about 0 degrees to about 2 degrees, so that effective retardation increases, resulting in a gradient of the liquid crystal lens panel 510. According to an embodiment, the second pretilt angle θ2 is about 2 degrees so that the second liquid crystal molecules have directivity.

Alternatively, the second alignment layer 544 includes a reactive polymer and allows the second liquid crystal molecules of the liquid crystal layer 550 adjacent to the second substrate 540 to be aligned in parallel or substantially in parallel with the second substrate 540 and to have directivity. For example, according to an embodiment, an exposure electric field state method is used to create the second alignment layer 544. The exposure electric field state method applies a voltage to the reactive polymer and irradiates ultraviolet UV rays more than about 3J to the reactive polymer.

Light transmitted through the display panel 410 in the second direction D2 passes through the second polarizing plate 545, the liquid crystal layer 550 and the first polarizing plate 533.

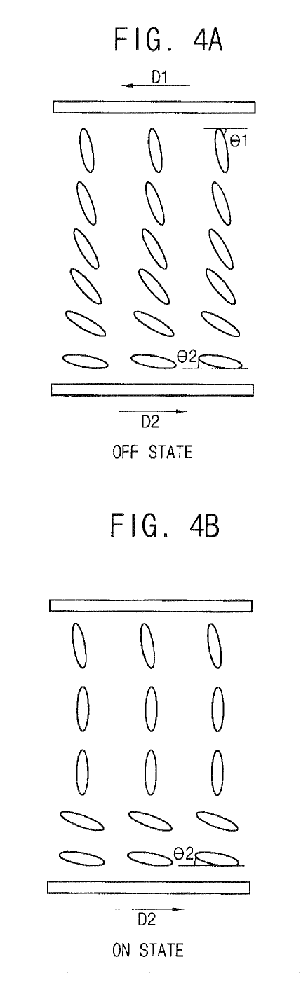

FIGS. 4A and 4B are views illustrating states of the liquid crystal molecules illustrated in FIG. 2 when application of a voltage turns on and off.

FIG. 4A illustrates a state of the liquid crystal molecules when there is no voltage application. For example, FIG. 4A illustrate an initial aligning state of the liquid crystal molecules.

Referring to FIG. 4A, the first liquid crystal molecules adjacent to the first substrate 530 are aligned substantially perpendicular to the first base substrate 531 while forming the first pretilt angle θ1 with respect to the first base substrate 531. The second liquid crystal molecules adjacent to the second substrate 540 are aligned substantially in parallel with the second base substrate 541 while forming the second pretilt angle θ2 with respect to the second base substrate 541.

Between the first liquid crystal molecules and the second liquid crystal molecules are disposed third liquid crystal molecules that move according to alignment of the first liquid crystal molecules and the second liquid crystal molecules. For example, according to an embodiment, the third liquid crystal molecules have a third pretilt angle between the first pretilt angle θ1 and the second pretilt angle θ2.

The first liquid crystal molecules are vertically or substantially vertically aligned, so that a falling time of the first and third liquid crystal molecules decreases, thus resulting in a reduced response time of the liquid crystal lens panel 510.

The first liquid crystal molecules have the first pretilt angle θ1, so that rising time is decreased, thus resulting in a reduced response time of the liquid crystal lens panel 510.

The second liquid crystal molecules have the second pretilt angle θ2 under about 2 degrees, so that the second liquid crystal molecules may increase effective retardation, so that a refractive index of the liquid crystal lens panel 510 may be easily formed.

According to an embodiment, the liquid crystal lens panel 510 has a refractive index more than about 550 nm. Vertical or substantially vertical alignment of the first liquid crystal molecules results in an increase in a cell gap of the liquid crystal lens panel 510, so that the liquid crystal lens panel 510 may have a predetermined refractive index.

The first alignment layer 532 is rubbed in the first direction D1, and the second alignment layer 544 is rubbed in the second direction D2. For example, the first and the second alignment layers 532 and 544 are rubbed in anti-parallel with each other. Accordingly, alignment stability of the liquid crystal molecules may be increased.

FIG. 4B illustrates a state of the liquid crystal molecules when there is voltage application.

Referring to FIG. 4B, the first liquid crystal molecules adjacent to the first substrate 530 and the third liquid crystal molecules are vertically or substantially vertically aligned quickly.

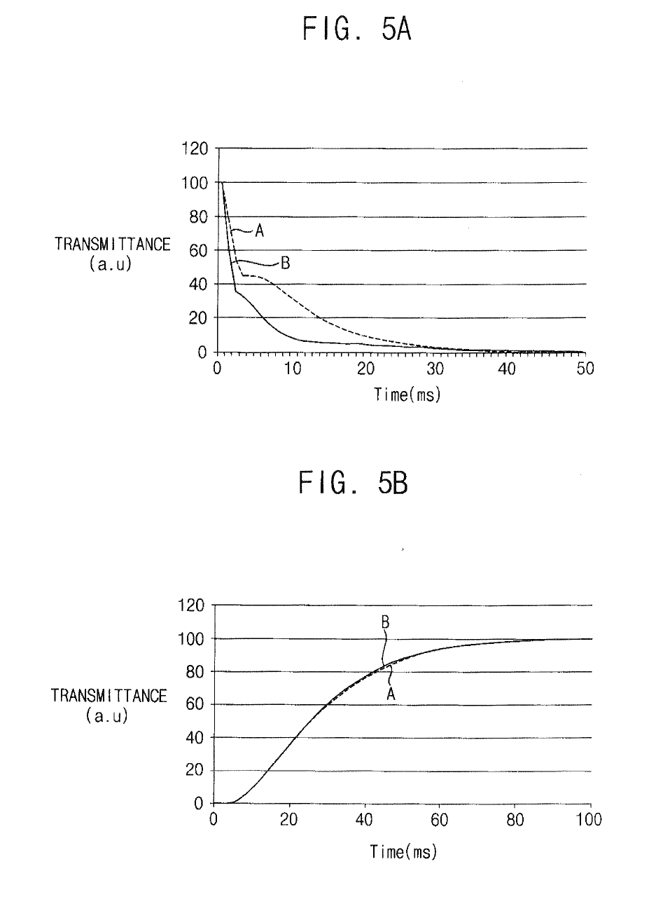

FIG. 5A is a graph illustrating a relationship between on-time and transmittance of liquid crystal molecules according to an embodiment of the present invention. FIG. 5B is a graph illustrating a relationship between off-time and transmittance of liquid crystal molecules according to an embodiment of the present invention.

Transmittance over time of liquid crystal molecules according to a conventional ECB (Electrically Controlled Birefringence) mode is denoted by ‘A’, and transmittance over time of liquid crystal molecules according to an embodiment of the present invention is denoted by ‘B’.

Referring to FIG. 5A, when an on-time of the liquid crystal molecules according to an embodiment of the present invention is about 9 ms, and an on-time of liquid crystal molecules according to the conventional mode is about 18 ms, the liquid crystal lens panel transmittance is 10%.

Accordingly, the on-time of the liquid crystal molecules according to the embodiment of the present invention may be reduced by about 50% compared with the conventional ECB mode.

Referring to FIG. 5B, the off-time of the liquid crystal molecules according to an embodiment of the present invention is substantially identical to the off-time of liquid crystal molecules according to a conventional ECB mode.

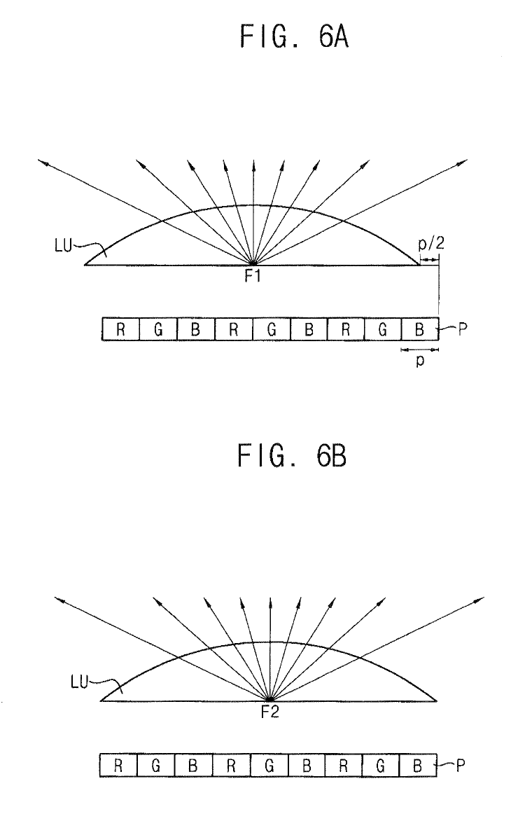

FIGS. 6A and 6B are views illustrating the number of viewpoints of even-numbered and odd-numbered frames according to embodiments of the present invention.

Referring to FIGS. 6A and 6B, pixels P display a three-dimensional stereoscopic image of first, third . . . , fifteenth, and seventeenth viewpoints during an odd-numbered frame and a three-dimensional stereoscopic image of second, fourth, . . . , sixteenth, and eighteenth viewpoints during an even-numbered frame.

The unit lens LU is operated to have a first focus place during the odd-numbered frame, and the unit lens LU is operated to have a second focus place F2 different from the first focus place F1 during the even-numbered frame. For example, according to an embodiment, the second focus place F2 is shifted by one half of a pixel p from the first focus place F1.

Accordingly, the stereoscopic display panel 100 may display a three-dimensional stereoscopic image of eighteen viewpoints during the odd-numbered frame and the even-numbered frame.

Although it has been described that the stereoscopic display panel 100 displays a three-dimensional stereoscopic image of eighteen viewpoints, according to an embodiment, the stereoscopic image display panel 100 may display a three-dimensional stereoscopic image of more than eighteen viewpoints.

According to an embodiment of the present invention, the response time of liquid crystal molecules in liquid crystal lens panel 510 is reduced, and the liquid crystal lens panel 510 may thus drive the odd-numbered frame and the even-numbered frame at high speed. As a result, the liquid crystal lens panel 510 may increase the number of viewpoints of the stereoscopic image display apparatus.

According to an embodiment of the present invention, the first liquid crystal molecules adjacent to the first substrate 530 are substantially vertically aligned at the first pretilt angle θ1. The second liquid crystal molecules adjacent to the second substrate 540 are substantially horizontally aligned at the second pretilt angle θ2. Thus, the light transmittance of the stereoscopic image display panel 100 is increased, and a response time of liquid crystal molecules is decreased.

Accordingly, the stereoscopic image display panel 100 may be driven at high speed, thus resulting in an increase in the number of the viewpoints.

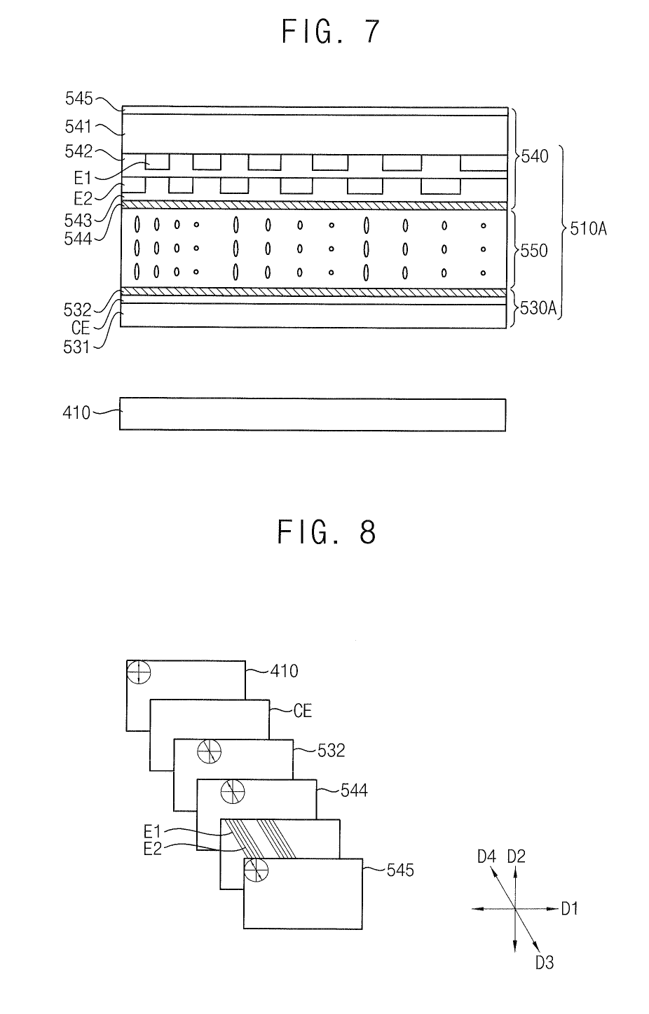

FIG. 7 is a cross-sectional view illustrating a liquid crystal lens panel of a stereoscopic image display panel according to an exemplary embodiment. FIG. 8 is a plan view illustrating a polarizing direction of the liquid crystal lens panel in FIG. 7.

The stereoscopic image display panel described in connection with FIGS. 7 and 8 is substantially identical to the stereoscopic image display panel described in connection with FIG. 1 except for the liquid crystal lens panel.

Referring to FIG. 7 and FIG. 8, the liquid crystal lens panel 510A includes a first substrate 530A facing the display panel 410, a second substrate 540 opposite to the first substrate 530A, and a liquid crystal layer 550 disposed between the first substrate 530A and the second substrate 540. Thus, the first substrate 530A is disposed between the display panel 410 and the second substrate 540.

The first substrate 530A includes a first base substrate 531, a common electrode CE and a first alignment layer 532. The first substrate 530A is substantially identical with the first substrate 530 described in connection with FIG. 1 except the first polarizing member is omitted.

The second substrate 540 is substantially identical with the second substrate 540 described in connection with FIG. 1.

Accordingly, light transmitted through the display panel 410 in the second direction D2 passes through the liquid crystal layer 550 and a second polarizing plate 545.

According to an embodiment, light transmitted through the display panel 410 experiences no or little retardation that may be caused by the liquid crystal layer 550 since the liquid crystal molecules in the liquid crystal layer 550 are vertically aligned. Accordingly, even though the first polarizing plate is omitted from the first substrate illustrated in FIG. 1, a loss of light transmitted through the display panel 410 may be reduced.

According to the exemplary embodiments of the present invention, the first liquid crystal molecules adjacent to the first substrate are aligned at a first pretilt angle with respect to the first substrate, and the second liquid crystal molecules adjacent to the second substrate are aligned at a second pretilt angle with respect to the second substrate. Thus, the response time of the liquid crystal molecules may be reduced.

The second liquid crystal molecules are aligned at an initial pretilt angle of no more than about 2 degrees. Thus, effective retardation may be increased, so that a refractive index of the liquid crystal lens panel may be easily formed.

The foregoing is illustrative of the embodiments of the present invention and is not to be construed as limiting thereof. Although a few exemplary embodiments of the present invention have been described, those skilled in the art will readily appreciate that many modifications are possible in the exemplary embodiments. Accordingly, all such modifications are intended to be included within the scope of the embodiments of the present invention as defined in the claims

What is claimed is:

1. A liquid crystal lens panel comprising:
a first substrate including a common electrode;
a second substrate including a plurality of first electrodes and a plurality of second electrodes, the first and second electrodes facing the common electrode; and
a liquid crystal layer between the first and second substrates, the liquid crystal layer including first and second liquid crystal molecules, wherein the first liquid crystal molecules are adjacent to the first substrate and aligned at a first pretilt angle with respect to the first substrate, and the second liquid crystal molecules are adjacent to the second substrate and aligned at a second pretilt angle with respect to the second substrate.

2. The liquid crystal lens panel of claim 1, wherein the first pretilt angle is from about 85 degrees to about 89 degrees, and the second pretilt angle is from about 0 degrees to about 2 degrees.

3. The liquid crystal lens panel of claim 1, wherein the liquid crystal layer further comprises third liquid crystal molecules between the first liquid crystal molecules and the second liquid crystal molecules, and wherein the third liquid crystal molecules have a third pretilt angle between the first pretilt angle and the second pretilt angle.

4. The liquid crystal lens panel of claim 1, wherein the first substrate further includes a first alignment layer on the common electrode, the first alignment layer configured to align the first liquid crystal molecules at the first pretilt angle, and wherein the second substrate further includes a second alignment layer on the first and second electrodes, the second alignment layer configured to align the second liquid crystal molecules at the second pretilt angle.

5. The liquid crystal lens panel of claim 4, wherein the first and second electrodes are extended in a first direction, and wherein the first alignment layer is rubbed in the first direction, and the second alignment layer is rubbed in a second direction opposite to the first direction.

6. The liquid crystal lens panel of claim 5, wherein the first substrate further comprises,
a first base substrate having a first surface and a second surface opposite to each other, wherein the common electrode is formed on the first surface of the first base substrate, and
a first polarizing member on the second surface of the first base substrate, and
wherein the second substrate further comprises,
a second base substrate having a first surface and a second surface opposite to each other, wherein the first and second electrodes are formed on the first surface of the second substrate, and
a second polarizing member on the second surface of the second base substrate, and
wherein at least one of the first or second polarizing member has a transmitting axis parallel or substantially parallel with the first or second direction.

7. The liquid crystal lens panel of claim 4, wherein the first alignment layer comprises a first reactive polymer configured to align the first liquid crystal molecules to have the first pretilt angle, and the second alignment layer comprises a second reactive polymer configured to align the second liquid crystal molecules to have the second pretilt angle.

8. The liquid crystal lens panel of claim 1, wherein voltages are applied to the first and second electrodes, respectively, so that the liquid crystal layer operates as a Fresnel lens.

9. A liquid crystal lens panel comprising:
a first base substrate;
a common electrode on the first base substrate;
a second base substrate facing the first base substrate;
a plurality of first electrodes and a plurality of second electrodes on the second base substrate, the first and second electrodes facing the common electrode;
a liquid crystal layer between the first and second electrodes and the common electrode;
a first alignment layer on the common electrode, the first alignment layer configured to align first liquid crystal molecules of the liquid crystal layer at a first pretilt angle with respect to first substrate, the first liquid crystal molecules adjacent to the common electrode; and
a second alignment layer on the first and second electrodes, the second alignment layer configured to align second liquid crystal molecules of the liquid crystal layer at a second pretilt angle with respect to the second substrate, the second liquid crystal molecules adjacent to the first and second electrodes.

10. The liquid crystal lens panel of claim 9, wherein the first pretilt angle is from about 85 degrees to about 89 degrees, and the second pretilt angle is from about 0 degrees to about 2 degrees.

11. The liquid crystal lens panel of claim 9, wherein the liquid crystal layer further comprises third liquid crystal molecules between the first liquid crystal molecules and the second liquid crystal molecules, and wherein the third liquid crystal molecules have a third pretilt angle between the first pretilt angle and the second pretilt angle.

12. The liquid crystal lens panel of claim 9, wherein the first and second electrodes are extended in a first direction, and wherein the first alignment layer is rubbed in the first direction, and the second alignment layer is rubbed in a second direction opposite to the first direction.

13. The liquid crystal lens panel of claim 12, wherein the first base substrate includes a first surface and a second surface opposite to each other, and the second base substrate includes a first surface and a second surface opposite to each other, wherein the common electrode is formed on the first surface of the first base substrate, and the first and second electrodes are formed on the first surface of the second base substrate, the liquid crystal lens panel further comprising:
a first polarizing member on the second surface of the first base substrate; and
a second polarizing member on the second surface of the second base substrate,
wherein at least one of the first or second polarizing member has a transmitting axis parallel or substantially parallel with the first or second direction.

14. The liquid crystal lens panel of claim 12, wherein voltages are applied to the first and second electrodes, respectively, so that the liquid crystal layer operates as a Fresnel lens.

15. A stereoscopic image display panel comprising:
a display panel configured to display an image; and
a liquid crystal lens panel disposed on the display panel, a liquid crystal lens panel configured to display the image as a stereoscopic image,
the liquid crystal lens panel including:
a first substrate including a common electrode;
a second substrate including a plurality of first electrodes and a plurality of second electrodes facing the common electrode; and
a liquid crystal layer between the first and second substrates, the liquid crystal layer including first and second liquid crystal molecules, wherein the first liquid crystal molecules are adjacent to the first substrate and aligned at a first pretilt angle with respect to the first substrate, and the second liquid crystal molecules are adjacent to the second substrate and aligned at a second pretilt angle with respect to the second substrate.

16. The stereoscopic image display panel of claim 15, wherein the first pretilt angle is from about 85 degrees to about 89 degrees, and the second pretilt angle is from about 0 degrees to about 2 degrees.

17. The stereoscopic image display panel of claim 15, wherein the second substrate is disposed between the first substrate and the display panel, wherein
the first substrate comprises,
a first base substrate having a first surface and a second surface opposite to each other, wherein the common electrode is formed on the first surface of the first base substrate;
a first alignment layer on the common electrode, the first alignment layer configured to align the first liquid crystal molecules at the first pretilt angle; and
a first polarizing member on the second surface of the first base substrate, and wherein
the second substrate comprises,
a second base substrate having a first surface and a second surface opposite to each other, wherein the first and second electrodes are formed on the first surface of the second substrate;
a second alignment layer on the first and second electrodes, the second alignment layer configured to align the second liquid crystal molecules at the second pretilt angle; and
a second polarizing member on the second surface of the second base substrate.

18. The stereoscopic image display panel of claim 17, wherein the first alignment layer is rubbed in a first direction, and the second alignment layer is rubbed in a second direction opposite to the first direction,
wherein the first polarizing member includes a transmitting axis parallel or substantially parallel with the first or second direction.

19. The stereoscopic image display panel of claim 15, wherein the first substrate is disposed between the display panel and a second substrate, and wherein
the first substrate includes:
a first base substrate; and
a first alignment layer on the common electrode, the first alignment layer configured to align the first liquid crystal molecules at the first pretilt angle, and wherein
the second substrate includes;
a second base substrate facing the first base substrate, the second base substrate having a first surface and a second surface opposite to each other, wherein the first and second electrodes are formed on the first surface of the second base substrate;
a second alignment layer disposed on the first and second electrodes, the second alignment layer configured to align the second liquid crystal molecules at the second pretilt angle; and
a polarizing member on the second surface of the second base substrate.

20. The stereoscopic image display panel of claim 19, wherein the first alignment layer is rubbed in a first direction, and the second alignment layer is rubbed in a second direction opposite to the first direction, and wherein the polarizing member has a transmitting axis parallel or substantially parallel with the first and second directions.

21. A liquid crystal panel comprising:
a first substrate;
a second substrate facing the first substrate;
a liquid crystal layer between the first and second substrates, wherein some of liquid crystal molecules in the liquid crystal layer, which are adjacent to the first substrate, are pre-tilted at a first angle with respect to the first substrate, and some of the liquid crystal molecules in the liquid crystal layer, which are adjacent to the second substrate, are pre-tilted at a second angle with respect to the second substrate.

22. The liquid crystal panel of claim 21, wherein the first angle is in a range from about 85 degrees to about 89 degrees, and the second angle is in a range from about 0 degrees to about 2 degrees.
